(19) United States
(12) Patent Application Publication
(10) Pub. No.: US 2025/0328902 A1
(43) Pub. Date: Oct. 23, 2025

(54) SYSTEMS AND PROCESSES FOR DIGITAL CREDIT OVER REAL-TIME PAYMENT RAILS

(71) Applicant: INNOVA SOLUTIONS, INC., Atlanta, GA (US)

(72) Inventors: Uma Sankar Kopalle, Aurora, IL (US); Swati Dublish, Piscataway, NJ (US); Manu Khurana, Bangalore (IN)

(21) Appl. No.: 19/187,466

(22) Filed: Apr. 23, 2025

Related U.S. Application Data
(60) Provisional application No. 63/637,449, filed on Apr. 23, 2024.

(51) Int. Cl. G06Q 20/40; G06Q 20/10; G06Q 20/22; G06Q 20/32

(52) U.S. Cl. CPC G06Q 20/401; G06Q 20/108; G06Q 20/227; G06Q 20/3274; G06Q 20/3276

(57) ABSTRACT

Systems and processes are disclosed for executing digital credit transactions over real-time payment rails. The disclosure includes generating, for a transaction, scannable computer readable media representative of user's payment account at a financial institution and transmitting the scannable computer readable media to an electronic computing device operated by the user. A merchant device can scan the scannable computer readable media from the electronic computing device to request payment for the transaction. A backend system can generate and transmit a payment request parameters based on an open banking application programming interface (API) corresponding to the financial institution and based on real-time payment rails operatively connected to the financial institution. The system can receive, from the financial institution, real-time payment rails metadata corresponding to the request for payment. The system can process the real-time payment rails metadata to determine a successful payment.

### CROSS REFERENCE TO RELATED APPLICATIONS

This application is a U.S. Non-Provisional patent application of, and claims the benefit of and priority to, U.S. Provisional Patent Application No. 63/637,449, filed on Apr. 23, 2024, and entitled “SYSTEMS AND PROCESSES FOR DIGITAL CREDIT OVER REAL-TIME PAYMENT RAILS,” the disclosure of which is incorporated by reference as if the same were set forth herein in its entirety.

### TECHNICAL FIELD

The present systems and processes relate generally to mobile payment systems, and more particularly to mobile payment systems for digital credit transactions over real-time payment rails.

### BACKGROUND

Conventional banking, credit, and payment systems are inefficient, especially with respect to transaction completion times and associated transaction fees. For example, in a typical transaction in which a customer purchases goods from a merchant, the merchant generally does not receive funds from the transaction until days after the actual transaction date. Moreover, the merchant typically does not receive the full transaction amount, given that numerous intermediaries in the transaction settlement process each charge respective transaction fees.

Moreover, consumer and commercial credit continues to be a popular financial tool. However, banks and financial institutions have largely been dependent on credit card processors and payment networks for providing retail credit cards to consumers, as well as commercial credit cards to businesses. The role of the credit card processors and payment networks in the payments network pipeline involves substantial cost with respect to the management of plastic/virtual cards and related processes given the numerous intermediaries in the value chain. Further, including credit card processors and payment networks in the conventional payments network pipeline also contributes to the length of time required for a payment or transaction to settle.

Therefore, there exists a long-felt but unresolved need for mobile payment systems for digital credit transactions over real-time payment rails.

### BRIEF SUMMARY OF DISCLOSURE

Briefly described, and according to one embodiment, aspects of the present disclosure generally relate to systems and processes for digital credit transactions over real-time payment rails.

In particular, and in various embodiments, the present disclosure relates to an improved mobile payments system which supports faster transaction speeds and incurs less transaction fees as compared to conventional payment networks.

In at least one example, the disclosed systems and processes allow for a user to receive access to “digital credit,” which represents a line of credit extended to the user by a bank (or any appropriate type of financial institution). In particular embodiments, rather than using a physical (or virtual) card for payment transactions (where the card is generally issued to the user by a third-party), the disclosed systems and processes allow for the user to directly access a line of credit via computer readable and/or scannable media (e.g., a quick response (QR) code, near field communication (NFC), radio frequency identification (RFID), or another similar digital code) that uniquely corresponds to the user's line of credit. Accordingly, in response to another party (e.g., a merchant) identifying and capturing the user's computer readable media, the user's credit can be accessed directly, and funds can transfer between accounts via real-time payment rails.

As will be understood and appreciated by one of ordinary skill in the art, real-time payment rails correspond to a payment processing network in which banks can transmit and receive money between other banks directly, instantaneously, securely, and irreversibly. In various embodiments, the real-time payment rails network can be supported by institutions such as The Clearing House® or the Federal Reserve Banks.

In various embodiments, a user can apply for a line of credit with a particular bank or financial institution, where the credit application/request process is performed via a software application that may be separate from any software application provided by the bank or financial institution. For example, the user may indicate, within the credit application process, with which bank or financial institution the user would like to open the line of credit. In particular embodiments, one or more financial institutions can extend or advertise various offers for lines of credit within the software application, from which the user can then select and apply for. In various embodiments, the financial institution that offers a line of credit is typically the institution that handles the processing of applications for that line of credit. However, in various certain embodiments, a user can be approved for a line of credit with a particular financial institution without said institution processing his/her credit application (for example, the user may be automatically approved if the user has extensive credit history within the herein disclosed platform, if the user has substantial assets, etc.). If the bank or financial institution approves the user's request, the user's line of credit can be displayed to the user on a software application downloaded on his/her mobile computing device. In certain embodiments, the user can also perform the credit application/request within a bank's software application (or for example, on the bank's website).

In one embodiment, the present systems, methods, and processes include a backend processing system. According to various aspects of the present disclosure, the backend processing system can include one or more servers, which may further include one or more processors, databases, routers, modems, network interfaces, etc. In particular embodiments, the backend processing system can also be cloud-based, such that computer processing capabilities are licensed, outsourced, or otherwise obtained from a third-party (e.g., AWS®, Azure®, etc.).

According to various aspects of the present disclosure, the backend processing system can maintain accounts for each user, merchant, organization, entity, etc., registered with the system. In particular embodiments, an account (such as a user's financial or credit account) can include an indication of a certain amount of credit available to that account holder.

Furthermore, the backend processing system can be operatively connected to one or more banks, financial institutions, etc., via open banking APIs or the like. In one embodiment, the open banking APIs leveraged by the backend processing system are built upon standards such as ISO 20022 and/or Financial Data Exchange (FDX) standards. Accordingly, in particular embodiments, the backend processing system is operatively configured to communicate with a bank's loan management system (LMS) or similar system for customer account management. In at least one embodiment, and in response to a bank approving a particular user's application/request for a line of credit submitted via the software application, the bank can indicate this new approved line of credit within its LMS for tracking and reporting purposes.

In various embodiments, and as briefly mentioned above, the backend processing system can support a software application, such as an application installed on an electronic computing device. In one embodiment, the application can be a mobile application installed on a mobile computing device such as a smart phone, tablet, wearable computing device, or generally any appropriate mobile computing device. In other embodiments, the application can be installed on generally stationary or fixed-position computing devices, such as computer-enabled cash registers or point-of-sale (POS) devices at a merchant's brick-and-mortar storefront.

In various embodiments, the backend processing system can generate computer readable media (e.g., a QR code, an image with information encoded therein, an NFC code, RFID, or any other appropriate type of digital or encoded representation or computer readable or scannable media) that corresponds to individual user accounts, individual transactions, transactions between specific parties, etc. Moreover, the backend processing system can transmit the computer readable media to an application at a user device, and/or to an application at a merchant device, which can then be presented on a display at the respective device. In one example, the computer readable media can be scanned (via a camera operatively connected to the user device, via a camera operatively connected to the merchant device, or by other appropriate means) in order to proceed with completing the transaction. In at least one embodiment, a user device and/or a merchant device can also generate the computer readable media.

According to various aspects of the present disclosure, the backend processing system can be operatively connected to a real-time payment rails system, such as the RTP® system provided by The Clearing House®, the FedNow® system provided by the Federal Reserve Banks, or another similar system or payments infrastructure.

As will be understood from the present disclosure, the embodiments discussed herein provide technical advantages over conventional payment systems. For example, conventional payment systems, and more specifically credit card payment systems, include a variety of intermediaries along the transaction pipeline such as payment processing companies, payment card networks (e.g., Visa®, MasterCard®, American Express®, etc.), the banks which support those payment networks, clearing houses, etc. Moreover, each of these intermediaries charges a fee and increases the overall time to payment settlement. In various embodiments, the intermediary fees are typically paid for by merchants, which are then generally offset by the consumer in the form of higher costs, fewer discounts, or some other financial detriment. According to various aspects of the present disclosure, the embodiments discussed herein overcome the problems with conventional credit card payment systems by avoiding the conventional system entirely. In particular, and as discussed herein, users/customers can apply for and receive credit directly with a bank (thus avoiding the need for the bank to partner with a credit card issuer), and users can access the credit for transactions via mobile computing devices (thus avoiding the need for credit card issuers, credit card payment processors, and credit card payment networks). Furthermore, the system disclosed herein leverages real-time payment rails. Accordingly, leveraging real-time payment rails allows for the system to transfer funds between banks directly and instantaneously, opposed to the multi-day timeline for settlement of funds in conventional credit card issuer payment systems.

In one example, the present disclosure describes a method including: transmitting, via a processor, a scannable computer readable media to an electronic computing device operated by a user, wherein the scannable computer readable media includes a user identification number encoded within the scannable computer readable media, the user identification number corresponding to a payment account belonging to the user at a financial institution; in response to a merchant device scanning the scannable computer readable media from the electronic computing device, receiving at the processor, from the merchant device, an approved payment amount, a merchant identification number, and the user identification number; generating, via the processor, payment request parameters based on the approved payment amount, the merchant identification number, and the user identification number, wherein the payment request parameters are further based on an open banking application programming interface (API) corresponding to the financial institution and real-time payment rails operatively connected to the financial institution; transmitting, via the processor, a request for payment authorization to the financial institution, wherein the request for payment authorization includes an open banking API call including the payment request parameters; receiving, from the financial institution, real-time payment rails metadata including a payment status corresponding to an outcome of the request for payment authorization; and transmitting the payment status to the electronic computing device, wherein the electronic computing device is operatively configured to provide the payment status to the merchant device.

In one or more examples, prior to transmitting the scannable computer readable media, the method further includes receiving an indication from the user corresponding to the user's selection of the payment account from one or more available payment accounts at one or more financial institutions.

In a particular example, the payment account includes a digital credit amount extended to the user by the financial institution. Further, in one or more examples, the open banking API call is in accordance with the ISO20022 standard.

According to various aspects of the present disclosure, the scannable computer readable media includes a quick response (QR) code. In particular embodiments, the QR code is operatively configured to be a valid code for a predetermined number of scans. In certain embodiments, a successful payment status in the real-time payment rails metadata corresponds to a completed transfer of value in the approved payment amount from the payment account to a merchant account associated with the merchant identification number.

In one or more examples, the present disclosure described a system including: a processor; and a memory on which are stored machine-readable instructions that when executed by the processor, cause the processor to: transmit a scannable computer readable media to an electronic computing device operated by a user, wherein the scannable computer readable media includes a user identification number encoded within the scannable computer readable media, the user identification number corresponding to a payment account belonging to the user at a financial institution; in response to a merchant device scanning the scannable computer readable media from the electronic computing device, receive, from the merchant device, an approved payment amount, a merchant identification number, and the user identification number; generate payment request parameters based on the approved payment amount, the merchant identification number, and the user identification number, wherein the payment request parameters are further based on an open banking application programming interface (API) corresponding to the financial institution and real-time payment rails operatively connected to the financial institution; transmit a request for payment authorization to the financial institution, wherein the request for payment authorization includes an open banking API call including the payment request parameters; receive, from the financial institution, real-time payment rails metadata including a payment status corresponding to an outcome of the request for payment authorization; and transmit the payment status to the electronic computing device, wherein the electronic computing device is operatively configured to provide the payment status to the merchant device.

According to various aspects of the present disclosure, and prior to transmitting the scannable computer readable media, the processor is further caused to receive an indication from the user corresponding to the user's selection of the payment account from one or more available payment accounts at one or more financial institutions. In one example, the payment account includes a digital credit amount extended to the user by the financial institution. In one or more examples, the open banking API call is in accordance with the ISO20022 standard.

In certain embodiments, the scannable computer readable media includes a quick response (QR) code. In particular embodiments, the QR code is operatively configured to be a valid code for a predetermined number of scans.

In at least one example, a successful payment status in the real-time payment rails metadata corresponds to a completed transfer of value in the approved payment amount from the payment account to a merchant account associated with the merchant identification number.

In one or more examples, the present disclosure describes a non-transitory computer readable medium including instructions, that when read by a processor, cause the processor to perform: transmitting a scannable computer readable media to an electronic computing device operated by a user, wherein the scannable computer readable media includes a user identification number encoded within the scannable computer readable media, the user identification number corresponding to a payment account belonging to the user at a financial institution; in response to a merchant device scanning the scannable computer readable media from the electronic computing device, receiving, from the merchant device, an approved payment amount, a merchant identification number, and the user identification number; generating payment request parameters based on the approved payment amount, the merchant identification number, and the user identification number, wherein the payment request parameters are further based on an open banking application programming interface (API) corresponding to the financial institution and real-time payment rails operatively connected to the financial institution; transmitting a request for payment authorization to the financial institution, wherein the request for payment authorization includes an open banking API call including the payment request parameters; receiving, from the financial institution, real-time payment rails metadata including a payment status corresponding to an outcome of the request for payment authorization; and transmitting the payment status to the electronic computing device, wherein the electronic computing device is operatively configured to provide the payment status to the merchant device.

In at least one example, the non-transitory computer readable further includes instructions that when read by the processor, cause the processor to perform, prior to transmitting the scannable computer readable media, receiving an indication from the user corresponding to the user's selection of the payment account from one or more available payment accounts at one or more financial institutions. In one example, the payment account includes a digital credit amount extended to the user by the financial institution. In one or more examples, the open banking API call is in accordance with the ISO 20022 standard. In various embodiments, the scannable computer readable media includes a quick response (QR) code. In a particular example, the QR code is operatively configured to be a valid code for a predetermined number of scans.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 shows a process flow associated with an example process, according to one aspect of the present disclosure;

FIG. 2 shows a sequence diagram and flowchart associated with an example process, according to one aspect of the present disclosure;

FIG. 3 shows a screenshot of an example graphical user interface, according to one aspect of the present disclosure;

FIG. 4 shows a screenshot of an example graphical user interface, according to one aspect of the present disclosure;

FIG. 5 shows a screenshot of an example graphical user interface, according to one aspect of the present disclosure;

FIG. 6 shows a screenshot of an example graphical user interface, according to one aspect of the present disclosure; and

FIG. 7 is a diagram of an example system, according to one aspect of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to systems and processes for digital credit transactions over real-time payment rails.

In particular, and in various embodiments, the present disclosure relates to an improved mobile payments system which supports faster transaction speeds and incurs less transaction fees as compared to conventional payment networks.

In at least one example, the disclosed systems and processes allow for a user to receive access to “digital credit,” which represents a line of credit extended to the user by a bank (or any appropriate type of financial institution). In particular embodiments, rather than using a physical (or virtual) card for payment transactions (where the card is generally issued to the user by a third-party), the disclosed systems and processes allow for the user to directly access a line of credit via computer readable and/or scannable media (e.g., a quick response (QR) code, near field communication (NFC), radio frequency identification (RFID), or another similar digital code) that uniquely corresponds to the user's line of credit. Accordingly, in response to another party (e.g., a merchant) identifying and capturing the user's computer readable media, the user's credit can be accessed directly, and funds can transfer between accounts via real-time payment rails.

As will be understood and appreciated by one of ordinary skill in the art, real-time payment rails correspond to a payment processing network in which banks can transmit and receive money between other banks directly, instantaneously, securely, and irreversibly. In various embodiments, the real-time payment rails network can be supported by institutions such as The Clearing House® or the Federal Reserve Banks.

In various embodiments, a user can apply for a line of credit with a particular bank or financial institution, where the credit application/request process is performed via a software application that may be separate from any software application provided by the bank or financial institution. For example, the user may indicate, within the credit application process, with which bank or financial institution the user would like to open the line of credit. If the bank or financial institution approves the user's request, the user's line of credit can be displayed to the user on a software application downloaded on his/her mobile computing device. In certain embodiments, the user can also perform the credit application/request within a bank's software application (or for example, on the bank's website).

In one embodiment, the present systems, methods, and processes include a backend processing system. According to various aspects of the present disclosure, the backend processing system can include one or more servers, which may further include one or more processors, databases, routers, modems, network interfaces, etc. In particular embodiments, the backend processing system can also be cloud-based, such that computer processing capabilities are licensed, outsourced, or otherwise obtained from a third-party (e.g., AWS®, Azure®, etc.).

According to various aspects of the present disclosure, the backend processing system can maintain accounts for each user, merchant, organization, entity, etc., registered with the system. In particular embodiments, an account (such as a user's financial or credit account) can include an indication of a certain amount of credit available to that account holder.

Furthermore, the backend processing system can be operatively connected to one or more banks, financial institutions, etc., via open banking APIs or the like. In one embodiment, the open banking APIs leveraged by the backend processing system are built upon standards such as ISO20022 and/or Financial Data Exchange (FDX) standards. Accordingly, in particular embodiments, the backend processing system is operatively configured to communicate with a bank's loan management system (LMS) or similar system for customer account management. In at least one embodiment, and in response to a bank approving a particular user's application/request for a line of credit submitted via the software application, the bank can indicate this new approved line of credit within its LMS for tracking and reporting purposes.

In various embodiments, and as briefly mentioned above, the backend processing system can support a software application, such as an application installed on an electronic computing device. In one embodiment, the application can be a mobile application installed on a mobile computing device such as a smart phone, tablet, wearable computing device, or generally any appropriate mobile computing device. In other embodiments, the application can be installed on generally stationary or fixed-position computing devices, such as computer-enabled cash registers or point-of-sale (POS) devices at a merchant's brick-and-mortar storefront.

In various embodiments, the backend processing system can generate computer readable media (e.g., a QR code, an image with information encoded therein, an NFC code, RFID, or any other appropriate type of digital or encoded representation or computer readable or scannable media) that corresponds to individual user accounts, individual transactions, transactions between specific parties, etc. Moreover, the backend processing system can transmit the computer readable media to an application at a user device, and/or to an application at a merchant device, which can then be presented on a display at the respective device. In one example, the computer readable media can be scanned (via a camera operatively connected to the user device, via a camera operatively connected to the merchant device, or by other appropriate means) in order to proceed with completing the transaction. In at least one embodiment, a user device and/or a merchant device can also generate the computer readable media.

According to various aspects of the present disclosure, the backend processing system can be operatively connected to a real-time payment rails system, such as the RTP® system provided by The Clearing House®, the FedNow® system provided by the Federal Reserve Banks, or another similar system or payments infrastructure.

As will be understood from the present disclosure, the embodiments discussed herein provide technical advantages over conventional payment systems. For example, conventional payment systems, and more specifically credit card payment systems, include a variety of intermediaries along the transaction pipeline such as payment processing companies, payment card networks (e.g., Visa®, MasterCard®, American Express®, etc.), the banks which support those payment networks, clearing houses, etc. Moreover, each of these intermediaries charges a fee and increases the overall time to payment settlement. In various embodiments, the intermediary fees are typically paid for by merchants, which are then generally offset by the consumer in the form of higher costs, fewer discounts, or some other financial detriment. According to various aspects of the present disclosure, the embodiments discussed herein overcome the problems with conventional credit card payment systems by avoiding the conventional system entirely. In particular, and as discussed herein, users/customers can apply for and receive credit directly with a bank (thus avoiding the need for the bank to partner with a credit card issuer), and users can access the credit for transactions via mobile computing devices (thus avoiding the need for credit card issuers, credit card payment processors, and credit card payment networks). Furthermore, the system disclosed herein leverages real-time payment rails. Accordingly, leveraging real-time payment rails allows for the system to transfer funds between banks directly and instantaneously, opposed to the multi-day timeline for settlement of funds in conventional credit card issuer payment systems.

### EXAMPLE EMBODIMENTS

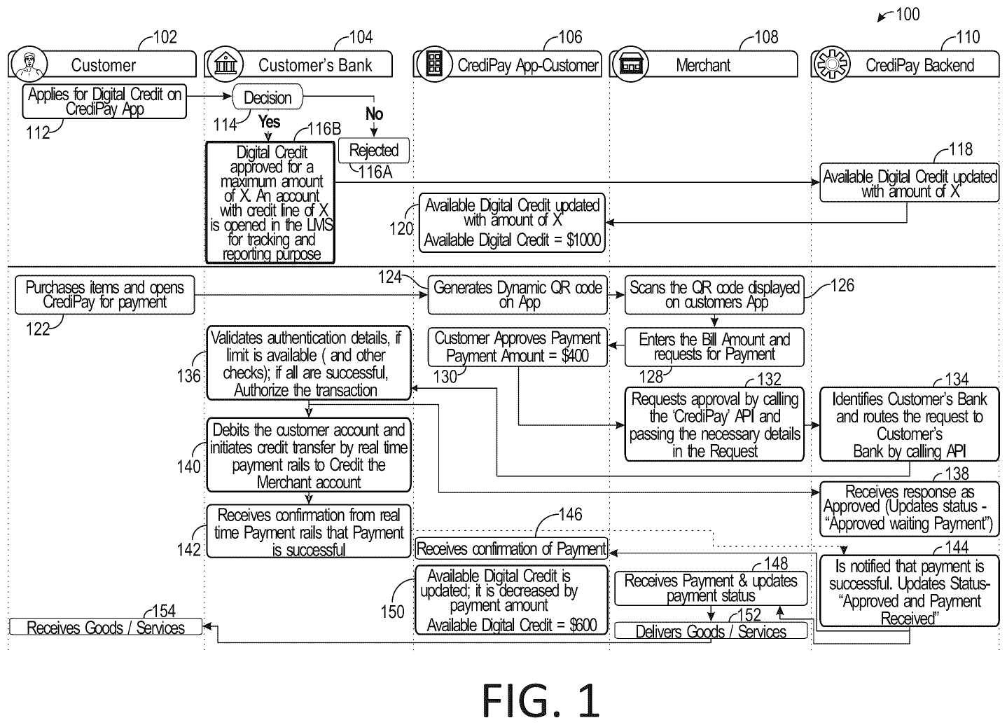

Referring now to the figures, for the purposes of example and explanation of the fundamental processes and components of the disclosed systems and processes, reference is made to FIG. 1, which shows a process flow 100 associated with an example system process, according to one aspect of the present disclosure. In one example, and as will be discussed in greater detail below, the process flow 100 generally shows a process by which a user applies for and receives access to digital credit, and furthermore uses the digital credit to complete a transaction with a merchant. As will be understood and appreciated, the process flow 100 shown in FIG. 1 represents merely one approach or embodiment of the present disclosure, and other aspects are used according to various embodiments of the present disclosure. Further, as will be understood by one having ordinary skill in the art, the steps and processes shown in FIG. 1 (and those of all other flowcharts and sequence diagrams shown and described herein) may operate concurrently and continuously, are generally asynchronous and independent, and are not necessarily performed in the order shown.

According to various aspects of the present disclosure, the process flow 100 may include a customer or user 102, a customer bank 104 (or any other appropriate financial institution), a software application 106 specifically registered to the user 102 (downloaded and installed on the user's computing device), a merchant 108 (and associated merchant payment systems and devices, such as point of sale systems), and a backend processing system 110 (also referred to herein as the backend system 110). In one embodiment, the process flow 100 can begin at step 112 when the user/customer 102 applies for digital credit. In various embodiments, the user 102 can apply for digital credit via a software application 106 installed and running on his/her mobile computing device. The user 102 can download the software application 106 and register an account via the application prior to initiating his/her application or request for digital credit. In response to registering an account via the application 106, the user's account can be maintained in a backend processing system 110. In various embodiments, in his/her application for digital credit, the user 102 can indicate with which bank the user wishes to open the line of digital credit. In certain embodiments, the software application 106 can match the user with (or suggest to the user) one or more banks or financial institutions with which the user may choose to open a line of credit (for example, based on terms, conditions, interest rates, etc., that are most favorable to the customer). As shown in the present embodiment, the user/customer 102 applies for a line of digital credit with the bank 104 (the customer's bank 104).

In response to applying for a line of credit with a bank 104 (or financial institution), the bank 104 at step 114 can process the user's application and determine whether to reject/deny the application (step 116A), or to approve the application (step 116B). If the user's application for digital credit is rejected, the process flow may end. However, if the user 102 is approved for a line of digital credit at step 116B, the bank 104 can generate a new digital credit account for the user in the bank's loan management system (LMS) for tracking and reporting purposes. In certain embodiments, at step 116B the user 102 is approved for digital credit up to a particular maximum amount (based on the user's application and/or based on the bank's 104 lending criteria). In one example, the maximum amount of digital credit can be reflected in the bank's LMS.

In various embodiments, and in response to the bank 104 approving the user's application for a line of digital credit, the bank 104 can transmit a notification to the backend processing system 110 regarding the approved line of credit. In response to the backend system 110 receiving the notification transmitted from the bank 104, at step 118 the backend processing system 110 can update the user's 102 account to reflect the user's available digital credit in accordance with the approved line of credit with the bank 104. In at least one embodiment, the user 102 may already have an account established with the backend system 110 before applying for digital credit with the bank 104. In various embodiments, a user's account at the backend system 110 can be a digital wallet, or the like, for holding the user's digital credit. Accordingly, and as illustrated at step 120, the software application 106 may display the user's account as having an available digital credit in the amount corresponding to the approved line of credit (and/or any other preexisting digital credit associated with the user's account). In certain embodiments, the user 102 can migrate preexisting lines of credit into the software application 106.

As shown in the present embodiment, at step 120, the software application 106 can display that the user 102 has a predetermined (approved) available digital credit (in the example shown in FIG. 1, the amount is $1,000). According to various aspects of the present disclosure, the available amount of digital credit indicated within the user's account and within the backend system 110 can resemble a digital twin or mirrored representation of the actual line of credit extended to the user 102 by the bank 104. Accordingly, the available amount of digital credit indicated within the user's account can be a true reflection of the amount of funds that can be transferred from the user's bank 104 to another account (whether internal or external to the bank 104) in response to the user 102 completing a transaction.

Continuing with the discussion of FIG. 1, the process flow 100 can proceed to step 122 where the user 102 initiates a transaction (e.g., purchasing goods or services). In various embodiments, and rather than presenting cash or a traditional debit/credit card to pay for the transaction, the user 102 can instead use the software application 106 for payment. For example, and at step 124, the software application 106 can generate computer readable or scannable media for payment. According to various aspects of the present disclosure, the software application 106 can generate a dynamic QR code for payment. In one example, the backend system 110 can generate a dynamic QR code for payment. In one or more examples, the user 102 can select a particular financial institution (or bank) from one or more financial institutions for completing payment, and the QR code can correspond to the user's selection. In at least one embodiment, the QR code is dynamic given a new QR code can be generated each time a QR code is displayed for payment. In certain embodiments, dynamic QR codes provide enhanced security against fraud, bad actors, etc., as compared to static QR codes, given dynamic QR codes are generally valid for a finite amount of time. In particular embodiments, the system can be configured such that the dynamic QR codes (or any computer readable media discussed herein) can be valid for a predetermined amount of time such as 1 second, 5 seconds, 30 seconds, 60 seconds, or any appropriate amount of time. In particular embodiments, the system can be configured such that the dynamic QR codes (or any computer readable media discussed herein) can be valid for a predetermined number of transactions such as 1 transaction, 2 transactions, 5 transactions, or any appropriate number of transactions. In various embodiments, the system can be configured such that the security parameters for the dynamic QR codes, or other computer readable media, can be adjusted as necessary.

In various embodiments, the computer readable media represents the user's account, and thus the amount of digital credit available to the user 102. In particular embodiments, the computer readable media can include other encoded information such as user and/or merchant identifiers, timestamps, geolocation data, transaction details, etc. In other examples, the software application 106 can generate various types of digital or electronic representations of the user's account, such as Bluetooth signals, near field communication signals, audio signals, etc.

In one embodiment, at step 126 the merchant 108 can scan the computer readable media generated by the software application 106. In at least one example, the merchant can scan a dynamic QR code as displayed on user's computing device screen. In certain embodiments, the software application 106 can be running and open on the user's device such that the software application 106 is presenting the computer readable media to be displayed. However, in other embodiments, the software application 106 can generate the computer readable media and transmit the computer readable media to another application to be displayed. For example, the software application 106 can generate the computer readable media in response to the user double-clicking a button on his/her device, performing a gesture or voice command, etc., and the software application 106 can furthermore transmit the generated computer readable media to a separate application (such as Apple Pay®) to be displayed on the device screen. In one embodiment, the software application 106 can be configured such that a user can position his/her device in close physical proximity to a merchant's POS terminal device, and the POS terminal device can obtain the computer readable media corresponding to the user's account. For example, the software application 106 can be configured to activate Bluetooth®, NFC, RFID, etc., within its respective device for communicating computer readable media corresponding to the user's account. In various embodiments, and in this way, the software application 106 can be configured such that the user need not open the software application (or even unlock or actively engage with his/her device) for generating code for payment and/or approving a payment.

In particular embodiments, the merchant 108 can scan the user's computer readable media, such as a dynamic QR code, with a merchant device such as a barcode scanner, a camera, a POS terminal device, etc. In particular embodiments, the software application 106 may require that the user's identity be authenticated or verified prior to allowing for the computer readable media to be displayed for scanning. For example, the software application 106 may prompt the user 102 to confirm his/her identity via a facial recognition process, a fingerprint recognition process, or the like.

In response to the merchant 108 scanning the computer readable media, the process 100 can proceed to step 128 where the merchant 108 can enter the transaction amount or bill corresponding to the transaction, thereby requesting payment from the user 102. In various embodiments, the merchant 108 can have an account with the backend system 110 and can also have its own instance of the software application downloaded and running on the merchant device. Accordingly, scanning the computer readable media can prompt the merchant 108, via the software application downloaded on the merchant device, to enter the transaction amount. In certain embodiments, the merchant 108 can enter the transaction amount on the user's device. In at least one embodiment, the computer readable media can be encoded with the transaction amount and details, and the user 102 and/or merchant 108 can confirm that the transaction details are correct.

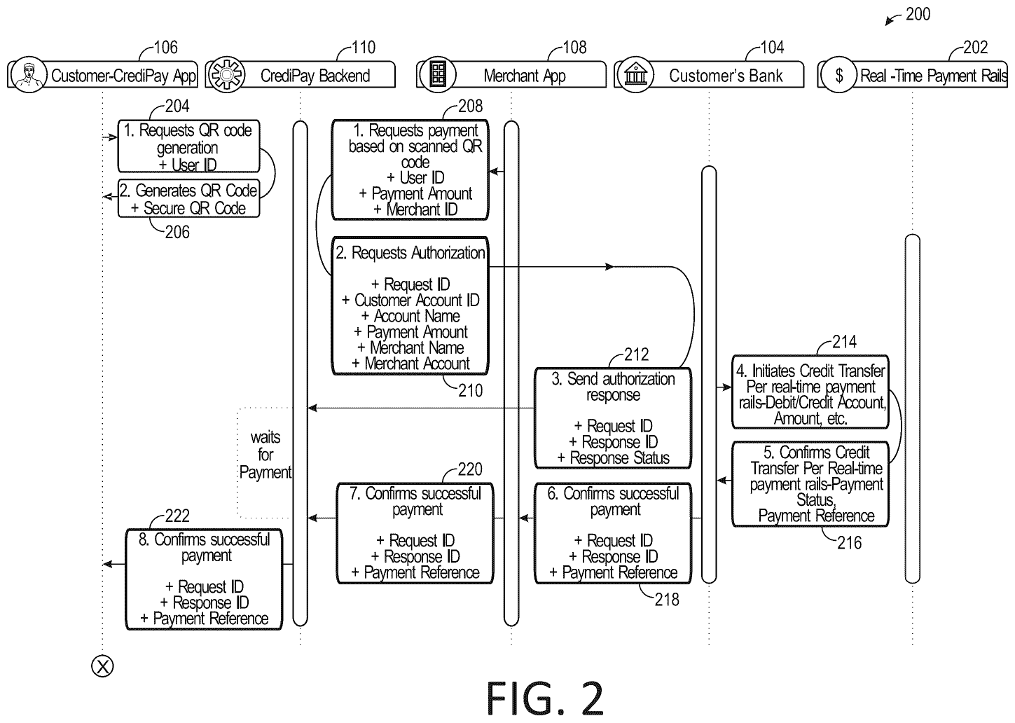

At step 130 the user 102 can receive, at the software application 106 running on his/her device, a notification corresponding to the transaction amount entered by the merchant at step 128. Accordingly, at step 130 the user 102 can see the transaction amount entered by the merchant 108 and the user 102 can confirm the transaction amount. As shown in the present example in FIG. 1, the transaction and corresponding amount is a payment for $400. The user 102 can confirm the payment on his/her device, which may in response initiate a confirmation transmission to the merchant 108. In at least one example, at step 132, the merchant 108, via the merchant device, can then request approval for settling the payment by generating a particular application programming interface (API) call. The API call can include the transaction details and other information/parameters regarding the request for payment (which will be discussed in greater detail below in association with the description of FIG. 2).

At step 134, an API call is received by the backend system 110. The backend system 110 can process the API call information and furthermore route the API call to the appropriate bank or financial institution for completing the transaction. For example, and referring specifically to the transaction between the user 102 and the merchant 108 in the present embodiment, the backend system 110 can process the API call to identify the user's bank 104 (based on identifiers in the API call) and furthermore route the request for payment to the user's bank 104. In various embodiments, the backend system 110 can determine the correct or compatible API for communicating with the user's bank 104. The backend system 110 can furthermore generate and populate a new API call (based on open banking API standards) to transmit to the bank based on the API call received from the merchant 108. Accordingly, at step 134, the backend system 134 can be operatively configured to generate one or more open banking API calls based on the information included in one or more received API call requests for approval of digital credit payments. In particular embodiments, the backend system 110 can route the merchant's API call to the bank 104.

In various embodiments, the process flow 100 can proceed to step 136, wherein the user's bank 104 can validate authentication details. For example, the user's bank 104 can determine if the user 102 has an amount of available credit that is sufficient to cover the transaction amount (the requested payment amount). In one example, if the validation is successful, the user's bank 104 can authorize the requested payment. In response to authorizing the transaction, the user's bank 104 can transmit a notification to the backend system 110 regarding the approved payment request (step 138), and the user's bank can debit the user's account and initiate a funds transfer via real-time payment rails to credit the merchant account (step 140). At step 138, as mentioned briefly above, the backend system 110 can update an internal payment status to “Approved waiting payment,” or a similar status, as the backend system 110 waits for confirmation of a successful transfer of funds (for example, based on transaction metadata received from the real-time payment rails).

According to various aspects of the present disclosure, at step 142 the user's bank 104 can receive an indication of the payment outcome. For example, at step 142 the user's bank 104 can receive confirmation from the real-time payment rails infrastructure that the payment to the merchant account was successful. The user's bank 104 can then transmit a notification to the backend system 110 regarding the successful payment. In one or more examples, the real-time payment rails can transmit a notification to the user 102 (the user's device) regarding a payment outcome. In one example, the notification can include one or more data packets including transaction information and metadata such as a payment status indicator, transaction reference number(s), account ID(s), etc. In various embodiments, at step 144 the backend system 110 can update the internal payment status to “Approved and Payment Received,” or a similar status (based on metadata included in the notification, such as a status indicator), and the backend system 110 can then notify the user 102 and merchant 108 regarding the successful transfer of funds. In particular embodiments, at step 146 the user's software application 106 can receive a notification from the backend system 110 confirming successful payment to the merchant 108, and the merchant can receive a similar notification at step 148. In at least one example, the merchant 108 can receive a confirmation of successful payment from the software application or integration installed at the merchant, and/or from the merchant's bank. In other embodiments, in response to the merchant's bank receiving funds via the real-time payment rails system, the merchant's bank can send a confirmation to the backend system 110, which can in turn be forwarded to the merchant 108 and the user's software application 106. In at least one example, in response to the real-time payment rails performing a transaction, or transfer of funds from the user's account to the merchant's account, the real-time payment rails system can return one or more data packets including real-time payment rails transaction metadata. For example, the real-time payment rails transaction metadata can include a payment/transaction status and a payment/transaction reference number or identifier. In one or more examples, the real-time payment rails transaction metadata can also a request ID, a response ID, and other metadata representative of the payment/transaction request.

In one embodiment, at step 150, the software application 106 updates the user's available digital credit amount to reflect the debited transaction amount. Accordingly, in this example, the user's digital credit amount can be updated to an amount of $600. In one example, at step 152, the merchant 108 can deliver the purchased goods or services to the user/customer 102, and at step 154 the user/customer 102 can receive the goods or services.

In sum, the process flow 100 outlines an improved payments process by which users/customers and merchants use scannable or readable media (or other similar encodings, including QR codes, barcodes, NFC readings, etc.) to represent digital credit accounts representative of actual funds backed by financial institutions. In response to a user and merchant initiating a transaction and requesting approval of the same, the system can be configured to generate API calls in accordance with real-time banking rails and open banking APIs to settle the transaction instantaneously and without the need for routing the transaction through conventional payment card pipelines.

Referring now to FIG. 2, a sequence diagram and flowchart (referred to herein as process flow 200) associated with an example process is shown, according to one aspect of the present disclosure. In one embodiment, the process flow 200 illustrates the sequence of steps performed, and the messages transmitted between the various system components, from initiation of a transaction to settlement of the same. According to various aspects of the present disclosure, the system components, devices, applications, etc., included in the process flow 200 are the software application 106 installed and running on the user/customer's device, the backend system 110, the merchant 108 device, the user's bank 104, and a real-time payment rails system 202.

In various embodiments, the process flow 200 can begin at step 204 where the software application 106 generates a request for computer readable or scannable media. In one embodiment, the request for computer readable media can be generated in response to the user 102 initiating a transaction and furthermore presenting the software application 106 as the method for payment. The software application 106 can generate the request for computer readable media and transmit the request, along with the user identification number (user ID), to the backend system 110. In one embodiment, the backend system 110 can generate computer readable media, such as a dynamic QR code, that corresponds to the user account associated with the software application 106 from which the request was transmitted. In particular embodiments, the backend system 110 can confirm that the user/customer maintains a digital credit account with an amount of available digital credit that is sufficient to fund the transaction, and the backend system 110 can transmit this confirmation to the software application 106 which can then generate the computer readable media. In various embodiments, the backend system 110 can transmit instructions to the software application 106 for generating the computer readable media. At step 206, the software application 106 can generate the computer readable media.

In one embodiment, at step 208 the merchant 108 (via a software application or integration installed on a device at the merchant 108) transmits to the backend system 110 a request for payment in response to scanning the computer readable media generated by the user's software application 106. In one example, at step 208 the merchant's request for payment includes the user ID, payment amount, and an identification number corresponding to the merchant (merchant ID). In response to receiving the payment request from the merchant 108, the backend system 110 can generate a request for authorization (step 210). The backend system 110 can transmit the request for authorization to the user's bank 104 (step 210). The backend system can determine to which bank to transmit the request for authorization based at least on the user ID included in the request for payment received from the merchant 108 at step 208. In various embodiments, the request for authorization transmitted by the backend system 110 to the user's bank 104 can include a request ID, a customer account ID, an account name, a payment account, a merchant name, and a merchant account. In particular embodiments, the request for authorization can be transmitted to the user's bank 104 via an open banking API call.

According to various aspects of the present disclosure, at step 212 the user's bank 104 can in return transmit to the backed system 110 an authorization response, in which the authorization response includes the request ID, a response ID, and a response status. In various embodiments, the response status can indicate whether the request for payment is approved and/or if payment has been successfully transferred. At step 212, the response status can be “Approved waiting payment,” or a similar status. Accordingly, the backend system 110 waits for a further indication of successful payment.

At step 214, the user's bank 104 can initiate a credit transfer, or a transfer of funds, in accordance with the information included in the authorization request received from the backed system at step 210. In various embodiments, initiating a credit transfer at step 214 can include transmitting an API call to the real-time payment rails system 202. In one example, the API call can include the payment account, the merchant account, the payment/transfer amount, and any other suitable information based on the real-time payment rails protocols. The real-time payments rails system 202 can resemble systems available through The Clearing House®, FedNow®, or similar systems and payment infrastructures. In at least one example, the actual funds transferred to the merchant can be withdrawn from the user's digital credit account at the bank 104, or the funds can be withdrawn from a larger pool of funds maintained within the bank 104 and the user's available credit can be reduced accordingly.

At step 216, the real-time payment rails system 202 can transmit to the user's bank 104 a confirmation notification regarding a successful transfer of credit/funds. In one example, the notification can include a payment reference number or identifier, a payment status, etc. In various embodiments, the user's bank at step 218 can transmit a confirmation of successful payment to the merchant 108. In various embodiments, the confirmation can include the request ID, the response ID, and the payment reference corresponding to the real-time payment rails transfer. According to various aspects of the present disclosure, at step 220 the merchant 108 can further transmit a confirmation of successful payment to the backend system 110. In particular embodiments, the confirmation transmitted to the backend system 110 can include the request ID, the response ID, and the payment reference corresponding to the real-time payment rails transfer.

According to various aspects of the present disclosure, in response to the backend system 110 receiving confirmation of successful payment (indicated by the real-time payment rails payment reference), the backend system 110 can in turn transmit a notification to the software application 106 on the user's device indicating a successful payment (step 222). In one example, the backend system 110 can include the request ID, the response ID, and the payment reference in the notification transmitted to the software application 106.

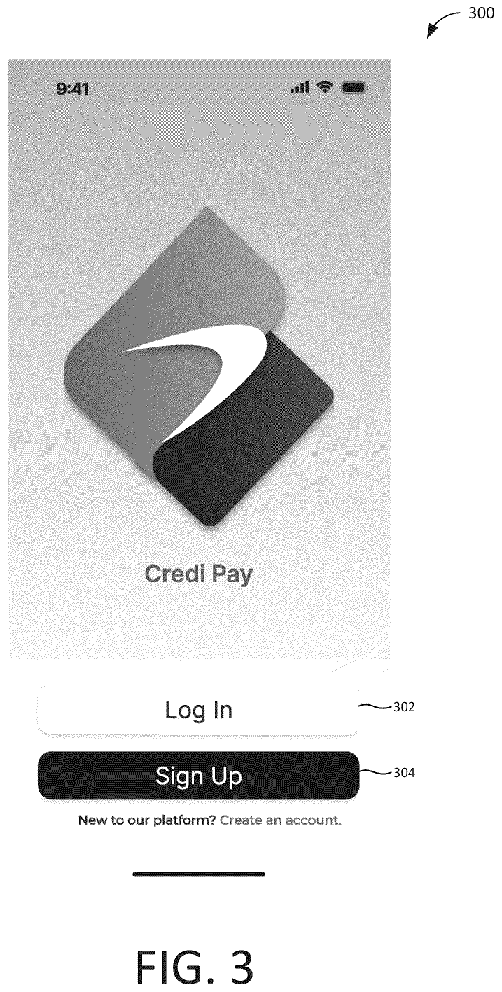

Turning now to FIG. 3, a screenshot of an example graphical user interface (GUI) login or landing page 300 is shown, according to one aspect of the present disclosure. In particular embodiments, the screenshot shows a login or landing page 300 for a software application through which users can pay for goods and services via digital credit. In various embodiments, the landing page 300 can present users with a log in option 302 or a sign up option 304. In certain embodiments, the software application can be configured such that a user can gain access through the landing page 300 via facial recognition, fingerprint recognition, or other similar secure methods.

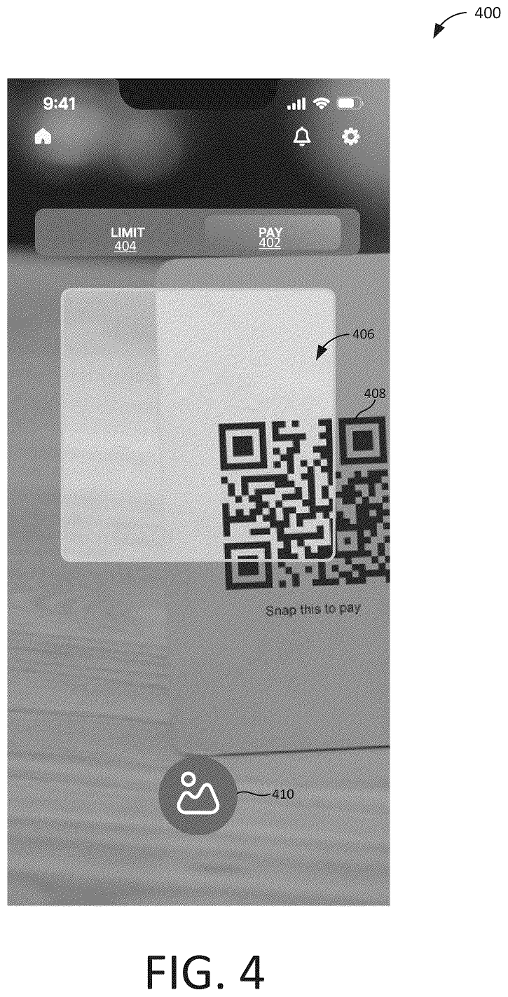

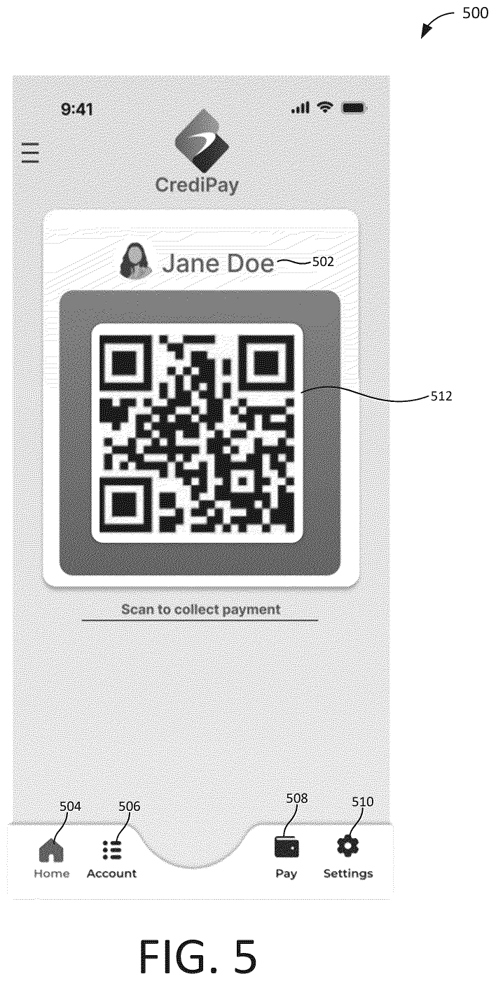

In one embodiment, FIG. 4 shows a screenshot of an example GUI for capturing scannable media (referred to herein as a payments GUI 400), according to one aspect of the present disclosure. While a primary embodiment of the present disclosure discusses a user/customer software application generating a computer readable code or media (as shown in FIG. 5, which is discussed below), which can subsequently be scanned by another device (such as a merchant device), the embodiment shown in FIG. 4 generally illustrates how a computer readable code can be scanned via the software application at any device on which it is downloaded. Accordingly, the payments GUI 400 can be presented to a user on his/her device for scanning computer readable codes generated by a merchant, or the payments GUI 400 can be presented to a merchant at a merchant device for scanning computer readable codes generated by the software application at the user device. As shown in the present embodiment, the computer readable code can be a printed QR code (for example, provided by a merchant) and a user can scan the printed QR code which may initiate the creation of a unique QR code at the user's device, or may result in the user's software application presenting the payments GUI 400 for initiating a payment with the merchant.

In at least one embodiment, the user can be presented with the payments GUI 400 in response to logging into the software application via the log in or landing page 300 and furthermore initiating a payment via the software application. In one example, the payments GUI 400 includes a pay tab 402 and a limit tab 404. As shown in the present embodiment, the pay tab 402 is selected. In various embodiments, when the pay tab 402 is selected, the payments GUI 400 can display a square region 406 (or a region of any appropriate shape) in which a QR code 408 can be positioned. In one embodiment, via a capture image button 410 on the payments GUI 400, a user can capture a picture of the QR code 408, which can in turn initiate a payments process. In certain embodiments, the QR code 408 shown in the present embodiment can resemble a dynamic QR code generated by and presented on a user's device (via the software application). In other embodiments, the QR code 408 can be a merchant QR code, and the user can scan the merchant QR code to initiate a transaction with the merchant.

In various embodiments, the limit tab 404 in the payments GUI 400 can be selected to display an available amount of digital credit.

In one embodiment, FIG. 5 shows a screenshot of an example GUI for displaying scannable media (referred to herein as a payments GUI 500). As discussed immediately above in connection with the description of FIG. 4, the software application can be operatively configured to capture, read, or otherwise scan (for example, via a camera or sensor at a device running the software application) a computer readable code positioned in close physical proximity to the device running the software application. However, and as shown in the embodiment illustrated in FIG. 5, the software application is also operatively configured to display a computer readable code, thereby allowing for the computer readable code to be read or scanned by another device.

In at least one example, the payments GUI 500 as shown in the present embodiment corresponds to a particular user, such as Jane Doe 502. According to various aspects of the present disclosure, Jane Doe 502 can be a user of the software application (such as the software application 106 as discussed herein). Moreover, Jane Doe 502 may have applied for, and subsequently been approved for, one or more lines of digital credit within the software application, such that Jane Doe 502 can use the one or more lines of digital credit for funding transactions.

In various embodiments, the payments GUI 500 includes selectable icons for navigating to different GUIs within the software application. For example, the payments GUI 500 includes a home icon 504 (which, if selected, can prompt the software application to display a home GUI), an account icon 506 (which, if selected, can prompt the software application to display an account GUI), a pay icon 508 (which, if selected, can prompt the software to display a payments GUI such as the GUIs 400 and 500), and a settings icon 510 (which, if selected, can prompt the software application to display an settings GUI).

According to various aspects of the present disclosure, a user can present the payments GUI 500 to a merchant to provide payment for a transaction. For example, consider a scenario in which Jane Doe 502 is paying for groceries at her local store. Rather than providing a physical credit card, bank card, or cash to the store for payment, Jane Doe 502 can instead present a unique computer readable code 512 for payment (shown as a QR code in the present embodiment). According to various aspects of the present disclosure, a device associated with or belonging to the store (such as a point-of-sale device, a smart phone operated by a cashier, etc.) can scan or otherwise read the computer readable code 512 from Jane Doe's device. In response to scanning the computer readable code 512, the store's device can establish a wireless electronic connection with Jane Doe's device over which the transaction details can be communicated. In particular embodiments, the store's device can route communication intended for Jane Doe's device through the backend system. For example, in response to scanning the computer readable code 512, the store's device can generate a payment request for the cost of Jane Doe's groceries, and the store's device can subsequently transmit the payment request to Jane Doe's device (either directly, or via the backend system). In at least one example, Jane Doe 502 can approve the payment request on her device and, assuming her account has sufficient digital credit for funding the transaction, can respond to the store's device with an approval notification. In various embodiments, Jane Doe 502 can approve the payment request within the payments GUI 500, or another separate GUI can be displayed in which Jane Doe 502 approves or rejects the payment request. Accordingly, in one example, the payments GUI 500 illustrates the digital environment through which system users can access and deploy their digital credit.

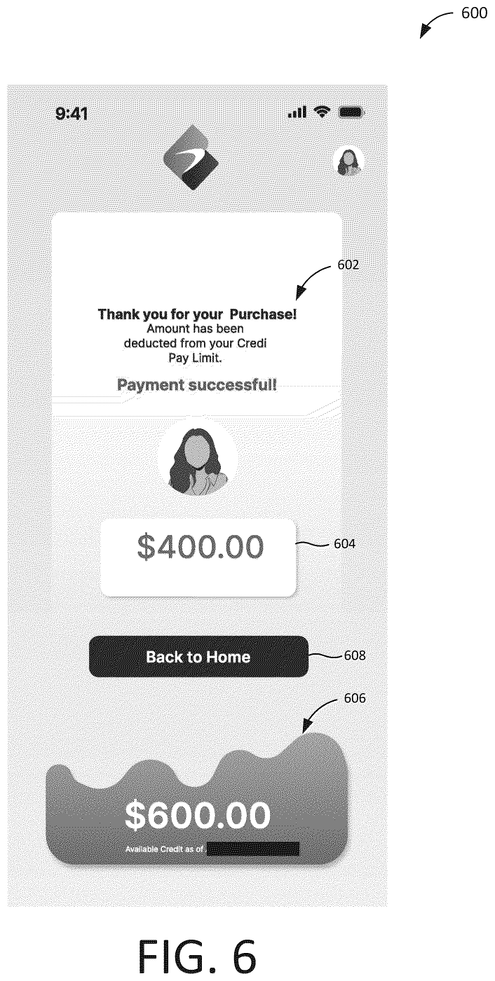

In various embodiments, FIG. 6 shows a screenshot of an example GUI payment confirmation page 600, according to one aspect of the present disclosure. In one example, the payment confirmation page 600 can represent a user receiving a notification from the backend system regarding successful payment (as discussed in association with step 222 in the description of FIG. 2). As shown in the present embodiment, the payment confirmation page 600 can include a confirmation notification 602, which includes a confirmation regarding the status of a transaction. In the present embodiment, the confirmation notification 602 indicates that payment for a purchase was successful, and that the purchase amount has been deducted from an available amount of digital credit. In various embodiments, a purchase amount 604 is shown towards the center of the payment confirmation page 600, and a remaining amount of available digital credit 606 is shown towards the bottom of the payment confirmation page 600. In various embodiments, the remaining amount of digital credit 606 is shown reflecting the deduction of the purchase amount 604. In one example, the payment confirmation page 600 can include a back to home tab 608, which when selected can prompt the software application to display a new GUI corresponding to a home page (through which the user can initiate additional transactions).

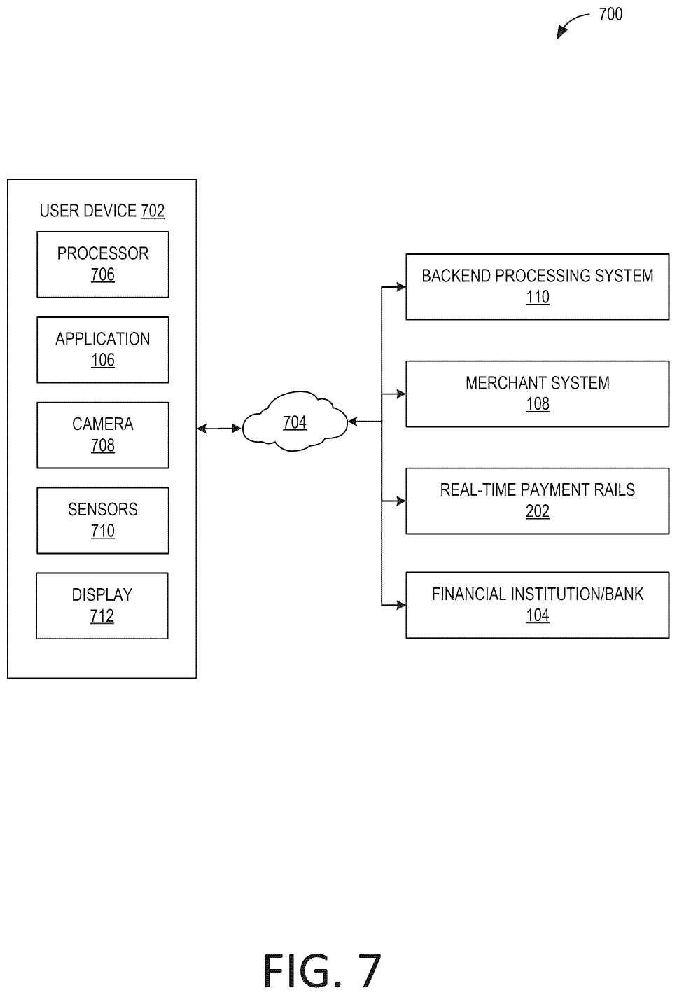

In one example, FIG. 7 is a diagram of an example architecture of the system 700. In at least one example, the system can include a user (or customer) device 702. In various embodiments, the user device 702 can include a wireless (or wired) connection via a network 704 to one or more financial institutions (e.g., banks) 104, the merchant system 108, the backend processing system 110, and the real-time payment rails 202. According to various aspects of the present disclosure, the user device 702 can be a smart phone, a tablet computer, a wearable computing device, or generally any type of electronic computer device with a processor, memory, display screen, and/or sensors for transmitting and receiving data. For example, the user device 702 can include a processor 706, a camera 708, one or more sensors 710, and a display 712. It should be understood from the discussion herein that the computing device 702 can include any computing component appropriate for scanning digital media, receiving digital media, generating and transmitting API calls (for example, open banking API calls), executing cardless payments, etc. In at least one example, the device 702 can be configured to run the application 106. In one or more examples, the processor 706 at the user device 702 can execute computer readable instructions corresponding to the application 106. In certain examples, the camera 708 at the device 702 can be operatively configured to scan a QR code (or other digital, scannable, or computer readable media) from the merchant system 108.

### ALTERNATE EMBODIMENTS

In various embodiments, the systems and processes disclosed herein can be applicable to a plurality of credit and financial arrangements. In particular embodiments, the systems and processes can be configured for “white label,” or store-branded, credit arrangements. As will be understood by one of ordinary skill in the art, “white label” credit is generally a line of revolving credit made available to a customer for use at a particular merchant (or various merchants). While a customer generally applies for “white label” credit with a particular merchant, a bank or another financial institution typically manages the credit account. Accordingly, rather than a user/customer applying for a line of digital credit directly with a bank (like in step 112 in the process flow 100), the user/customer can apply for the line of digital credit with the intended merchant. The merchant can then provide the user/customer's digital credit application details to the merchant's bank (or whichever bank manages the merchant's lines of digital credit), and the bank can perform an eligibility and underwriting process for the user/customer's application. If approved, the bank can establish an account for the user/customer in the bank's LMS. Accordingly, the account within the LMS can be established for the user/customer, but the user account is linked to the merchant from which the user/customer's application for credit was provided. In response to establishing the user/customer account, the user/customer can proceed to user his/her digital credit as discussed throughout the present disclosure.

In another embodiment, the systems and processes disclosed herein can be configured for corporate, or commercial, credit arrangements. For example, a corporation may obtain a line of credit, and the corporation can further extend (to members of the corporation) individualized access to that line of credit. According to various aspects of the present disclosure, a corporation, entity, or an individual, can apply for an enterprise line of credit with a bank. In one example, the application process for an enterprise line of credit can be similar to an application for a typical line of credit; however, the bank may require proof of certain business documents. If the bank approves the applicant for an enterprise line of credit, the applicant can determine one or more individuals (generally members of applicant's corporation) to which credit is to be extended. The line of credit extended to the applicant can be referred to as the master credit line, and any subordinate line of credit extended to others on behalf of the master credit holder is a sub-account that cannot exceed the line of credit extended to the applicant. Accordingly, in this example, a corporation can apply for a master line of credit for $1000. The bank can establish an account for the corporation and update the corporation's available amount of digital credit to be $1000. The corporation can then request for sub-accounts to be created for two separate users (User A and User B), where User A is extended access to $400 in digital credit, and User B is extended access to $600 in digital credit. In this way, members of a corporation can be extended access to a master line of credit, and access to the line of credit can be limited and customized on a case-by-case basis per individual.

### CONCLUSION

The disclosure herein can be carried out wholly or in part by a computing environment, which can include a server computer, or any other system providing computing capability. Alternatively, the computing environment may employ a plurality of computing devices that may be arranged, for example, in one or more server banks or computer banks or other arrangements. Such computing devices can be located in a single installation or may be distributed among many different geographical locations. For example, the computing environment can include a plurality of computing devices that together may include a hosted computing resource, a grid computing resource, and/or any other distributed computing arrangement. In some cases, the computing environment can correspond to an elastic computing resource where the allotted capacity of processing, network, storage, or other computing-related resources may vary over time.

Various applications and/or other functionality may be executed in the computing environment according to various embodiments. Also, various data is stored in a database that is accessible to the computing environment. The database can be representative of a plurality of databases as can be appreciated. The data stored in the database, for example, may be associated with the operation of the various applications and/or functional entities described herein.

The computing environment can communicate with a plurality of computing devices and querying devices (which may include computing devices) via a network. The network includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

Aspects, features, and benefits of the systems, methods, processes, formulations, apparatuses, and products discussed herein will become apparent from the information disclosed in the figures and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the figures or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the systems and processes to the precise forms disclosed. Many modifications and variations are possible in light of the above teaching.

The embodiments were chosen and described in order to explain the principles of the systems and processes and their practical application so as to enable others skilled in the art to utilize the systems and processes and various embodiments and with various modifications as are suited to the particular use contemplated. Alternative embodiments will become apparent to those skilled in the art to which the present systems and processes pertain without departing from their spirit and scope. Accordingly, the scope of the present systems and processes is defined by the appended claims rather than the foregoing description and the exemplary embodiments described therein.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed systems and processes may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed systems and processes are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems and processes are embodied. The logical connections between computers include a local area network (LAN), a wide area network (WAN), virtual networks (WAN or LAN), and wireless LAN (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the systems and processes is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems and processes will be readily discernible from the description herein, by those of ordinary skill in the art. M any embodiments and adaptations of the disclosure and claimed systems and processes other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems and processes. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems and processes. In addition, some steps may be carried out simultaneously, contemporaneously, or in synchronization with other steps.

The embodiments were chosen and described in order to explain the principles of the claimed systems and processes and their practical application so as to enable others skilled in the art to utilize the systems and processes and various embodiments and with various modifications as are suited to the particular use contemplated. Alternative embodiments will become apparent to those skilled in the art to which the claimed systems and processes pertain without departing from their spirit and scope. Accordingly, the scope of the claimed systems and processes is defined by the appended claims rather than the foregoing description and the exemplary embodiments described therein.

What is claimed is:

1. A method comprising:
transmitting, via a processor, a scannable computer readable media to an electronic computing device operated by a user, wherein the scannable computer readable media comprises a user identification number encoded within the scannable computer readable media, the user identification number corresponding to a payment account belonging to the user at a financial institution;
in response to a merchant device scanning the scannable computer readable media from the electronic computing device, receiving at the processor, from the merchant device, an approved payment amount, a merchant identification number, and the user identification number;
generating, via the processor, payment request parameters based on the approved payment amount, the merchant identification number, and the user identification number, wherein the payment request parameters are further based on an open banking application programming interface (API) corresponding to the financial institution and real-time payment rails operatively connected to the financial institution;
transmitting, via the processor, a request for payment authorization to the financial institution, wherein the request for payment authorization comprises an open banking API call comprising the payment request parameters;
receiving, from the financial institution, real-time payment rails metadata comprising a payment status corresponding to an outcome of the request for payment authorization; and
transmitting the payment status to the electronic computing device, wherein the electronic computing device is operatively configured to provide the payment status to the merchant device.

2. The method of claim 1, wherein prior to transmitting the scannable computer readable media, further comprising receiving an indication from the user corresponding to the user's selection of the payment account from one or more available payment accounts at one or more financial institutions.

3. The method of claim 1, wherein the payment account comprises a digital credit amount extended to the user by the financial institution.

4. The method of claim 1, wherein the open banking API call is in accordance with the ISO 20022 standard.

5. The method of claim 1, wherein the scannable computer readable media comprises a quick response (QR) code.

6. The method of claim 5, wherein the QR code is operatively configured to be a valid code for a predetermined number of scans.

7. The method of claim 1, wherein a successful payment status in the real-time payment rails metadata corresponds to a completed transfer of value in the approved payment amount from the payment account to a merchant account associated with the merchant identification number.

8. A system comprising:
a processor; and
a memory on which are stored machine-readable instructions that when executed by the processor, cause the processor to:
transmit a scannable computer readable media to an electronic computing device operated by a user, wherein the scannable computer readable media comprises a user identification number encoded within the scannable computer readable media, the user identification number corresponding to a payment account belonging to the user at a financial institution;
in response to a merchant device scanning the scannable computer readable media from the electronic computing device, receive, from the merchant device, an approved payment amount, a merchant identification number, and the user identification number;
generate payment request parameters based on the approved payment amount, the merchant identification number, and the user identification number, wherein the payment request parameters are further based on an open banking application programming interface (API) corresponding to the financial institution and real-time payment rails operatively connected to the financial institution;
transmit a request for payment authorization to the financial institution, wherein the request for payment authorization comprises an open banking API call comprising the payment request parameters;
receive, from the financial institution, real-time payment rails metadata comprising a payment status corresponding to an outcome of the request for payment authorization; and
transmit the payment status to the electronic computing device, wherein the electronic computing device is operatively configured to provide the payment status to the merchant device.

9. The system of claim 8, wherein prior to transmitting the scannable computer readable media, the processor is further caused to receive an indication from the user corresponding to the user's selection of the payment account from one or more available payment accounts at one or more financial institutions.

10. The system of claim 8, wherein the payment account comprises a digital credit amount extended to the user by the financial institution.

11. The system of claim 8, wherein the open banking API call is in accordance with the ISO 20022 standard.

12. The system of claim 8, wherein the scannable computer readable media comprises a quick response (QR) code.

13. The system of claim 12, wherein the QR code is operatively configured to be a valid code for a predetermined number of scans.

14. The system of claim 8, wherein a successful payment status in the real-time payment rails metadata corresponds to a completed transfer of value in the approved payment amount from the payment account to a merchant account associated with the merchant identification number.

15. A non-transitory computer readable medium comprising instructions, that when read by a processor, cause the processor to perform:
transmitting a scannable computer readable media to an electronic computing device operated by a user, wherein the scannable computer readable media comprises a user identification number encoded within the scannable computer readable media, the user identification number corresponding to a payment account belonging to the user at a financial institution;
in response to a merchant device scanning the scannable computer readable media from the electronic computing device, receiving, from the merchant device, an approved payment amount, a merchant identification number, and the user identification number;
generating payment request parameters based on the approved payment amount, the merchant identification number, and the user identification number, wherein the payment request parameters are further based on an open banking application programming interface (API) corresponding to the financial institution and real-time payment rails operatively connected to the financial institution;
transmitting a request for payment authorization to the financial institution, wherein the request for payment authorization comprises an open banking API call comprising the payment request parameters;
receiving, from the financial institution, real-time payment rails metadata comprising a payment status corresponding to an outcome of the request for payment authorization; and
transmitting the payment status to the electronic computing device, wherein the electronic computing device is operatively configured to provide the payment status to the merchant device.

16. The non-transitory computer readable medium of claim 15, further comprising instructions that when read by the processor, cause the processor to perform, prior to transmitting the scannable computer readable media, receiving an indication from the user corresponding to the user's selection of the payment account from one or more available payment accounts at one or more financial institutions.

17. The non-transitory computer readable medium of claim 15, wherein the payment account comprises a digital credit amount extended to the user by the financial institution.

18. The non-transitory computer readable medium of claim 15, wherein the open banking API call is in accordance with the ISO20022 standard.

19. The non-transitory computer readable medium of claim 15, wherein the scannable computer readable media comprises a quick response (QR) code.

20. The non-transitory computer readable medium of claim 19, wherein the QR code is operatively configured to be a valid code for a predetermined number of scans.
